(19) United States
(12) Patent Application Publication
(10) Pub. No.: US 2022/0369672 A1
(43) Pub. Date: Nov. 24, 2022

(54) Drink Beverages

(71) Applicant: WET HOLDINGS (GLOBAL) LIMITED, Kenilworth (GB)

(72) Inventors: Michael Adams, Knowle, Solihull (GB); Ahmed Mohamed, Birmingham (GB)

(21) Appl. No.: 17/761,735

(22) PCT Filed: Sep. 18, 2020
(86) PCT No.: PCT/IB2020/058716

§ 371 Date: Mar. 18, 2022

(30) Foreign Application Priority Data
Sep. 18, 2019 (GB) 1913486.5

(51) Int. Cl. A23L 2/66; A23L 2/04; A23L 2/58; A23L 2/60

(52) U.S. Cl. CPC A23L 2/66; A23L 2/04; A23L 2/58; A23L 2/60

(57) ABSTRACT

Methods and formulations for bottled or packaged or canned drinks in which the aqueous phase and capsules including hydrophobic ingredients that coexist with each other without emulsification or dispersion. The aqueous phase may include any consumable liquid including, but not limited to, alkaline water or mineral water or carbonated water or spring water or juice or flavoured drink or any other consumable liquids. The hydrophobic ingredient(s), including oils, liquids and chewables, are encapsulated in capsules, of varying sizes and shapes, made of edible material(s).

### FIELD OF THE INVENTION

The present invention relates to methods and formulations for drink beverages which may be provided in, for instance, bottles, packages or cans.

### BACKGROUND OF INVENTION

Drinks are liquids that are intended for human consumption. Despite the aqueous nature of drinks, they contain a variety of essential ingredients which are hydrophobic, such as flavours (natural or artificial), clouding agents, weighting agents, nutraceuticals, oil-soluble vitamins, and oil-soluble antimicrobials. This means that these ingredients cannot simply be dispersed directly into an aqueous phase as they would rapidly separate due to external forces, including gravitational forces, leading to formation of a layer of oil on top of the drink product or a powdery-like material floating in the aqueous phase of the drink or deposits at the bottom of the drink bottle. To overcome this obstacle, drinks have to be converted into colloidal dispersions consisting of flavour (or other hydrophobic or oily ingredients) molecules encapsulated within small particles suspended within an aqueous medium, e.g., an emulsion, a microemulsion, or a nano-emulsion. However, these colloidal delivery systems must be carefully designed to provide desirable physicochemical, biological, and sensory attributes to the final drink product. Among the desirable attributes of colloidal delivery system suitable for drinks industry are: Composition (delivery system should be fabricated from food-grade and label friendly components that are economic and easy to handle), stability (delivery system should withstand all types of stresses a drink product may experience during production, storage, transportation, etc), physicochemical and sensory properties (delivery system should not adversely affect the optical properties, rheology, or flavour profiles) and others.

Currently, drink emulsions are manufactured by either high-energy approaches or low-energy approaches. High-energy approaches include the use of high-pressure valve homogenizers, microfluidizers and continuous ultrasonic homogenizers. On the other hand, low-energy approaches includes the use of emulsion inversion point method, spontaneous emulsification and phase inversion temperature method. Recently, nano-technology has provided an advanced method for manufacturing emulsions, particularly nano-emulsions (i.e. emulsions with droplet size of <100 nm). However, each type of emulsion produced by the aforementioned methods has its own advantages and disadvantages. For instance, emulsions (with droplet size >100 nm) are often opaque and thermodynamically unstable. Microemulsions (with droplet size <100 nm) are transparent or slightly turbid but thermodynamically stable. Nano-emulsions, on the other hand, transparent or slightly turbid and thermodynamically stable. Yet, Food Safety authorities, particularly in Europe, have recently imposed restrictions on the use of nano-technology and nano-emulsions in food and beverages industry. A Drink that contains nano-emulsions or used nano-technology during production must undergo a lengthy and a strict certification and licensing process in order to enter into the European market.

In this invention, we present methods and formulations for manufacturing of bottled or packaged or canned drinks in which the aqueous phase and the essential hydrophobic ingredients coexist with each other without dispersion or emulsification. The hydrophobic and/or oily ingredients are encapsulated in edible macro-capsules (termed: marbles) made of various materials, including but not limited to, a plant extract, a seaweed extract or a mixture of both, or seaweed extracts or gelatine or collagen or other edible materials which are all immersed in the aqueous phase. Thus, in this invention, a drink is made of an aqueous phase comprising water or alkaline water or flavoured drink or any other type of drink in which a plurality of the aforementioned marbles, immersed in the aqueous phase and comprising a flavour(s), sugar, natural sweetener(s), artificial sweetener(s), cloudifying agent(s), colouring agent(s), and any other oily components such CBD oils, vitamins, antibiotics and others encapsulated within edible bubble made of a plant extract or seaweed extract or mixture of both or gelatine or collagen or any other edible material(s).

### STATEMENTS OF THE INVENTION

In this present invention, embodiments of bottled or packaged or canned drinks that comprise macro-capsules that coexist with and within the aqueous phase of the drink. The macro-capsules (termed: marbles) comprise an outer shell that is made of edible material(s) and encapsulates hydrophobic ingredients and other ingredients as well. In this way, essential hydrophobic drink ingredients can be added to the aqueous phase in bottled or packaged or canned drinks without the need for emulsification or dispersion. As result of the embodiments of this present invention, bottled or packaged or canned drinks can contain essential hydrophobic ingredients without the unpleasant formation of oily layers or drink cloudiness or materials deposits at the bottom of the bottles/packs/cans, which is an unwelcome experience by both drink developers/bottlers and consumers as it is often perceived as sign of drink spoiling or running out of expiration date.

From a consumers perspective, the consumption of the embodiments in this present invention, with its marbles that contain various ingredients, would enable consumers to enjoy a surprising unique palatability experience of tasting two or more flavours in a given bottled/packaged/canned drink or a surprising unique chewing experience while drinking a bottled/packaged/canned drink or even entertain the surprising experience of consuming oily ingredients while drinking the bottled/packaged/canned drink.

More importantly, the embodiments in this present invention would enable consumers to enjoy an unprecedented freedom to whether consume a healthy non-sugary drink or alternatively a sugar containing drink from the same bottled/packaged/canned drink. By having sugar containing marbles that coexist within an aqueous phase made of mineral water or alkaline water or non-sugar containing drink, the consumer can decide on whether to just drink the non-sugar containing aqueous phase or alternatively consume some or all of the sugar containing marbles as well as the non-sugary aqueous phase. In this way, the onus on the consumer to make the healthy/non healthy decision while consuming the embodiments of the bottled/packaged/canned drinks in this present invention.

The invention provides methods and embodiments of bottled/packaged/canned drink formulations in which the aqueous phase of the drink comprise macro-capsules (termed “marbles” in this present invention). The aqueous phase could be any consumable liquid while the marbles comprise an outer shell and an inner core that comprise hydrophobic ingredients or any other ingredients.

The aqueous phase in this present invention could be mineral water or alkaline water or spring water or purified water or carbonated water or juice or smoothie or carbonated drink or flavoured drink or fermented drink or non-alcoholic spirit drinks or CBD drink or tea infusions or smoothies or any other consumable drink or a mixture of any of the aforementioned consumable liquids.

The marbles in this present invention comprise of an outer shell that coats or encapsulates an inner core.

The outer shell of the said marbles comprises a layer or multiple layers of edible and malleable materials including, but not limited to, plant extracts, seaweed extracts, gelatin, collagen, agar, sugar films or a mixture of the aforementioned materials or any other edible malleable materials.

The inner core of the said marble may contain, but not limited to, any or a combination of the following components: drink(s), flavour(s), colouring agent(s), vitamin(s), antibiotics, CBD and/or THC oils, syrups, sugars, natural sweeteners or any other edible or chewable or drinkable ingredient.

Preferably, the shape of the marbles may be spherical, and their size may range from a minimum of 2.1 mm or above. Rectangular marbles and other geometrical shapes could be fashioned as well.

Optionally, an embodiment of the present invention may comprise marbles of 1 size, 1 shape and 1 core ingredient or alternatively may comprise marbles of various shapes and sizes and core ingredients inside the same bottled/packaged/canned drink.

The embodiment of formulations of the aqueous phase and/or the drinks encapsulated within the marbles in this invention may include drinks, formulations, exemplary procedural or other details supplementary to those set forth herein, are specifically incorporated herein by reference to patents with assigned publication numbers GB2550794 and WO2019/243759, and a patent with assigned application number GB1916731.1.

Preferred drink formulations in the aqueous phase and/or the drinks encapsulated within the marbles of the present invention may also include antioxidants, flavoring agent(s), preservative(s), or a combination thereof. More preferably, oral solutions include all three elements (i.e. an antioxidant, a flavoring, and a preservative). Preferred antioxidants include, but not limited to, butylated hydroxytoluene (BHT), butylated hydroxyanisole (BHA), or combinations thereof. Suitable preservatives include, but not limited to, methylparaben, methylparaben sodium, propylparaben, or combinations thereof. Propylparaben and methylparaben are preferred preservatives, and combinations of the two are more preferred.

Flavorings suitable to include in drinks formulations in the aqueous phase and within the said marbles of the present invention are natural flavours including, but not limited to, orange, red fruits, lemon lime, vanilla, apple, strawberry, kiwi, ginger and ginseng or various combinations thereof. It may also include sugars or artificial sweeteners or natural sweeteners including, but not limited to, stevia.

Additionally, syrups could be encapsulated within the marbles and may include, but not limited to grape syrup, grape cherry syrup, bubble gum, almond oil, anise oil, cherry syrup, clove oil, lemon oil, licorice fluid extract, orange oil or syrup, peppermint oil, vanilla tincture or combinations thereof.

Other elements that optionally may be included in the said drink formulations in the aqueous phase and/or the drinks encapsulated within the marbles of the present invention include, but not limited to, amino acids, vitamins, minerals, phospholipids, cyclodextrins, triglycerides, diglycerides, monoglycerides, ionic surfactants, non-ionic surfactants, fatty acids, buffers, or any combinations thereof.

Preferably, vitamins used in the formulations in the aqueous phase and/or the drinks encapsulated within the marbles of the invention may include, but not limited to, Vitamin C, Vitamin A, Vitamin E, Vitamin B1-12 at varying concentrations.

Phospholipids suitable for inclusion in formulations of in the aqueous phase and/or the drinks encapsulated within the marbles of the present invention may include, but not limited to, phosphotidyl choline, phophotidyl ethanolamine, sphingomylein, lauroyl polyoxylglyceride, linoleoyl polyoxylglyceride, oleoyl polyoxylglyceride, lecithin, soy isoflavones, or combinations thereof.

Cyclodextrins suitable for inclusion in liquid solutions in the aqueous phase and/or the drinks encapsulated within the marbles of the present invention may include, but not limited to, α cyclodextrin, β cyclodextrin, δ cyclodextrin, γcyclodextrin, or combinations thereof.

Suitable triglycerides for formulations in the aqueous phase and/or the drinks encapsulated within the marbles of the present invention may include, but not limited to, olive oil, safflower oil, soybean oil, sunflower oil, or combinations thereof. Fatty acids suitable for use in the invention include, but not limited to, oleic acid, stearic acid, α-lipoic acid, ethyl oleate, myristic acid, palmitic acid, sorbitan monolaurate, sorbitan monooleate, sorbitan monopalmitate, sorbitan monostearate, sorbitan trioleate, or combinations thereof.

Any of the following amino acids may be included in formulations in the aqueous phase and/or the drinks encapsulated within the marbles of the present invention: alanine, arginine, aspartic acid, choline, folic acid, glutamine, glycine, histidine, isoleucine, leucine, lysine, methionine, phenylalanine, serine, threonine, tryptophan, tyrosine, valine, or combinations thereof or any other amino acids.

Buffers may be included in formulations in the aqueous phase and/or the drinks encapsulated within the marbles of the present invention. This includes, but not limited to, the following: ascorbic acid, ascorbyl palmitate, calcium sulfate, citric acid, dibasic sodium phosphate, monobasic sodium phosphate, potassium carbonate, potassium citrate, sodium acetate, sodium ascorbate, sodium bicarbonate, sodium carbonate, sodium citrate, sodium lauryl sulfate, sodium metabisulfate, or combinations thereof.

Surfactants may be suitable for inclusion in formulations in the aqueous phase and/or the drinks encapsulated within the marbles of the present invention may include, but not limited to, aqueous sodium laurel sulfate, a tocopherol excipient, tocopherol polyethyleneglycol, beta-carotene, lycopene, or combinations thereof.

Preferably, CBD and/or THC oils may be encapsulated within the said marbles. The concentration and dosage of CBD and THC are within the permissible legal limits.

Alternatively, edible oil ingredients may be encapsulated within the said marbles. The encapsulated oils may include, but not limited to, olive oil, sesame oil, fruit extracted oils, or others.

Preferred drink formulations in the aqueous phase and/or the drinks encapsulated within the marbles of the present invention may or may not include sugars, artificial sweeteners or natural sweeteners including, but not limited to, stevia.

Chewable edible ingredients may be included in the said marbles including, but not limited to, natural gums and/or synthetic gum ingredients or combinations thereof. Natural gums may include marine seaweed gums and/or botanical gums and/or bacterial fermentation produced gums. Marine seaweed gums may include agar, alginic acid, and carrageenan. Botanical gum may include polyelectrolytes such as Gum arabic, Gum ghatti, Gum tragacanth, and Karaya gum. Also, botanical gum may include uncharged gums such as Guar gum, Locust bean gum, Beta-glucan, Dammar gum, Tara gum, and Glucomannan. Bacterial fermentation produced gums may include polyelectrolyte gums (such as Gellan gum) or uncharged gums (such as Xanthan gum). On the other hand, synthetic gums may include, but not limited to, Polyox resins and/or vinyl polymers. Vinyl polymers may include, but not limited to, Polyvinylpyrollidone (PVP), Carboxyvinyl polymer, Poly, and Polyvinyl alcohols.

This patent also provides embodiments of alkaline drinks (pH 8-11) whereby micro-encapsulated ingredients are used in the said alkaline drinks. This is particularly applicable to alkaline drinks produced by methods, apparatuses, and procedures related to patents with assigned publication numbers GB2550794 and WO2019/243759, and a patent with assigned application number GB1916731.1.

It will be clear to the skilled artisan that a variety of optional ingredients may be included in formulations of the invention. An exemplary embodiment of the invention comprises marble drink formulations comprising alkaline water, marbles comprising CBD oil, group of marbles comprising first flavouring (for example natural lemon lime flavouring), second group of marbles comprising second flavouring (for example marbles comprising natural strawberry flavouring), third group of marbles comprising maple syrup, fifth group of marbles comprising multi-vitamin complex, sixth group of marbles comprising first colouring agent (for example yellow), seventh group of marbles comprising second colouring agent (for example pink), and eighth group of marbles comprising natural sweetener stevia.

This patent also provides methods of production of the embodiments in this present invention which are produced by an amalgamation of standard and novel bottled/packaged/canned drinks processes. In general, the bottling or packaging of the embodiments in this present invention involves the following steps: water treatment or purification, water carbonation (optional), syrup production and mixing (optional), blending (optional), macro-encapsulation or marbles production, filling, macro-capsules or marbles sorting and filling, packaging or bottling.

The water treatment or purification methods used in this present invention may include any of the commonly used methods of water treatment and purification in the beverages industry including, but not limited to, reverse osmosis filtration, carbon filtration, micro- or nano-filtration, UV purification, ozone purification, desalination, de-ionisation filtration, and/or aeration. By using the aforementioned methods, water from various sources may be used including boreholes, spring water, river water, sea water or any other.

The present invention may also include the use of the methods, apparatuses, formulations, exemplary procedural or other details supplementary to those set forth herein for the production of alkaline water, are specifically incorporated herein by reference to patents with assigned publication numbers GB2550794 and WO2019/243759, and a patent with assigned application number GB1916731.1.

Optionally, water carbonation, syrup production and mixing, flavours and/or additives mixing, and syrup blending methods may all or some be used in the production of the embodiments in this present invention. Water carbonation may be employed if the aqueous phase in the embodiment comprise carbonated water or carbonated drink. Syrup production and mixing, flavours and/or additives mixing, and blending methods may all or some be employed when the aqueous phase or the core of the marbles comprise flavoured drink(s), juice(s), carbonated flavoured drink(s), CBD drink(s), non-alcoholic spirit drink(s), fermented drink(s), or any drink that may comprise flavouring agent(s), colouring agent(s), aromatic agent(s), or any of the ingredients mentioned herein, or any other consumable ingredients.

Filling methods and apparatuses may be employed to fill in the bottles or packs or cans with the aqueous phase of the embodiments in this present invention. The present embodiments may be bottled or packaged in PET or PETE bottles, glass bottles, carton packs, Tetrapacks, metal bottles or cans, or any other bottling or packaging materials used in the beverages industry.

Macro-encapsulation or marble production may be employed for the production of the marbles in this present invention. The embodiments in this present invention comprise marbles of various sizes and shapes including, but not limited to spheres (preferably), rectangles, triangles or other geometrical shapes. The size of the marbles vary but may not be smaller than 2 mm in size. For instance, spherical marbles may not have a size with diameter of 2 mm.

The shapes and sizes of the marbles in this present invention may be produced by various commonly used micro-encapsulation methods. Preferably, the double-nozzle process of microcapsules, by Brace GmbH, may be employed by adjusting the size parameters in the production of the marbles in this present invention. Additionally, the parameters of the thickness of the said shell, number of layers of the said shell, the quantity/volume of the said core materials are all to be adjusted, as well, to produce the macro-capsules in accordance with the present invention. The aforementioned method enables the creation of an outer hard shell encapsulating either a hard or soft (liquid) ingredients. It is also preferred for the production of marbles whereby the encapsulated ingredients are aimed to be released at once when pressure is applied during biting or chewing.

The materials used in the production of the outer shell of the marble may comprise plant extract(s) or seaweed extract(s) or collagen(s) or polymers such as gelatin, agar-agar, alginates or synthetic polymers such as resins or organics such as paraffin, fatty acids, waxes, or a mixture of any of the aforementioned materials, or any other liquids or materials that may be employed by the encapsulation methods.

Sorting of the marbles and filling of the bottles or packs or cans with the sorted marbles in the embodiments in this present invention may be employed to ensure filling the bottled/packaged/canned drink with the correct amount, size, shape, and type (e.g. colour type, core ingredient types) of marbles. This step is preferred to be employed prior to filling the bottles/packs/cans with the aqueous phase during production.

### BRIEF DESCRIPTION OF THE DRAWINGS

The accompanying drawing is:

FIG. 1 is an exemplary diagrammatic view of a bottled marble drink in accordance with the embodiments in the present invention;

FIG. 2 is an exemplary three-dimensional diagrammatic view of a marble in accordance with the embodiments in the present invention;

FIG. 3 is a diagrammatic flow chart view of the production processes employed during the production of the embodiments in the present invention.

### DETAILED DESCRIPTION OF THE INVENTION

The invention will now be described, by way of examples only, with reference to the accompanying drawing.

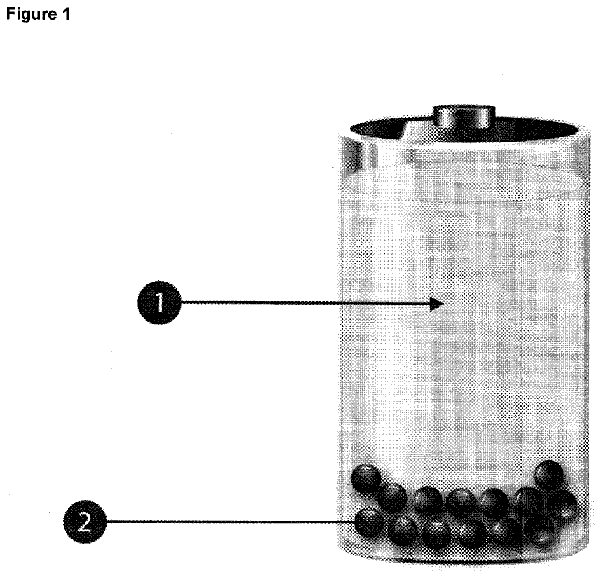

With reference to FIG. 1 of the accompanying drawings, a Marble Drink comprises an aqueous phase 1 which coexists with macro-capsules 2 (termed marbles in this present invention). The marbles 2 do not disperse or dissolve or form an emulsion with the aqueous phase 1.

The embodiment of formulations of the aqueous phase 1 and/or the drinks encapsulated within the marbles 2 in this invention include drinks, formulations, exemplary procedural or other details supplementary to those set forth herein, are specifically incorporated herein by reference to patents with assigned publication numbers GB2550794 and WO2019/243759, and a patent with assigned application number GB1916731.1.

Alternatively, the aqueous phase 1, in accordance with the present invention, could be any consumable liquid but preferably mineral water or alkaline water or spring water or carbonated water or juice or smoothies or flavoured drink or carbonated drink or fermented drinks or CBD drinks or tea infusions or any other drink category or a mixture of any of the aforementioned consumable liquids.

The marbles 2, in accordance with present invention, comprise of an outer shell of an edible material and inner core comprising edible or drinkable or chewed ingredient(s) that may be hydrophobic in nature. The outer shell may be made of edible materials including, but not limited to, plant extracts or seaweed extracts or a mixture of both or gelatin or collagen or any other materials mentioned herein.

The edible or drinkable or chewable ingredient(s) encapsulated within the marbles 2, in accordance with the present invention, may contain, but not limited to, any or a combination of the following components: drink(s), flavour(s), colouring agent(s), vitamin(s), antibiotics, CBD and/or THC oils, syrups, sugars, natural sweeteners or any other edible or drinkable or chewable ingredient(s).

Preferably, the shape of the marbles 2 could be spherical, and their size may not be less than 2 mm in diameter. Rectangular marbles and triangular marbles or other geometrical shapes could be fashioned as well.

An embodiment of the present invention may include marbles of 1 size, 1 shape and contain 1 ingredient inside a bottled/packaged/bottled drink. Alternatively, a bottled/packaged/canned drink, in accordance with the present invention, may include marbles of various sizes, shapes and contain various ingredients.

Preferred embodiments of drink formulations in the aqueous phase 1 and/or the drinks encapsulated within the marbles 2 of the present invention include, but not limited to, antioxidants, flavoring agent(s), preservative(s), or a combination thereof. More preferably, oral solutions include all three elements (i.e. an antioxidant, a flavoring, and a preservative). Preferred antioxidants may include, but not limited to, butylated hydroxytoluene (BHT), butylated hydroxyanisole (BHA), or combinations thereof. Suitable preservatives comprise, but not limited to, methylparaben, methylparaben sodium, propylparaben, or combinations thereof. Propylparaben and methylparaben are preferred preservatives, and combinations of the two are more preferred.

Flavorings that may be suitable for the drinks formulations in the aqueous phase 1 and within the said marbles 2 of the present invention may include, but not limited to, natural flavours such as orange, red fruits, lemon lime, vanilla, apple, strawberry, kiwi, ginger and ginseng or various combinations thereof or any other flavourings. It may also include sugars or artificial sweeteners or natural sweeteners including, but not limited to, stevia.

Additionally, syrups could be encapsulated within the marbles 2 and they may include, but not limited to, grape syrup, grape cherry syrup, bubble gum, almond oil, anise oil, cherry syrup, clove oil, lemon oil, licorice fluid extract, orange oil or syrup, peppermint oil, vanilla tincture or any other syrups or any combinations thereof.

Other elements that optionally may be included in the said drink formulations of in the aqueous phase 1 and/or the drinks encapsulated within the marbles 2 of the present invention include, but not limited to, amino acids, vitamins, minerals, phospholipids, cyclodextrins, triglycerides, diglycerides, monoglycerides, ionic surfactants, non-ionic surfactants, fatty acids, buffers, or any combinations thereof.

Preferably, vitamins used in the formulations in the aqueous phase 1 and/or the drinks encapsulated within the marbles 2 of the invention may include, but not limited to, Vitamin C, Vitamin A, Vitamin E, Vitamin B1-12 at varying concentrations.

Phospholipids suitable for inclusion in formulations of in the aqueous phase 1 and/or the drinks encapsulated within the marbles 2 of the present invention may include, but not limited to, phosphotidyl choline, phophotidyl ethanolamine, sphingomylein, lauroyl polyoxylglyceride, linoleoyl polyoxylglyceride, oleoyl polyoxylglyceride, lecithin, soy isoflavones, or combinations thereof.

Cyclodextrins suitable for inclusion in liquid solutions in the aqueous phase 1 and/or the drinks encapsulated within the marbles 2 of the present invention may include, but not limited to, α cyclodextrin, β cyclodextrin, δ cyclodextrin, γcyclodextrin, or combinations thereof.

Suitable triglycerides that may be included in formulations in the aqueous phase 1 and/or the drinks encapsulated within the marbles 2 of the present invention may include, but not limited to, olive oil, safflower oil, soybean oil, sunflower oil, or combinations thereof. Fatty acids that may be included in the invention, but not limited to, oleic acid, stearic acid, α-lipoic acid, ethyl oleate, myristic acid, palmitic acid, sorbitan monolaurate, sorbitan monooleate, sorbitan monopalmitate, sorbitan monostearate, sorbitan trioleate, or combinations thereof.

Any of the following amino acids may be included in formulations in the aqueous phase 1 and/or the drinks encapsulated within the marbles 2 of the present invention: alanine, arginine, aspartic acid, choline, folic acid, glutamine, glycine, histidine, isoleucine, leucine, lysine, methionine, phenylalanine, serine, threonine, tryptophan, tyrosine, valine, or combinations thereof. Other amino acids may be included too.

Buffers may be included in formulations in the aqueous phase 1 and/or the drinks encapsulated within the marbles 2 of the present invention. In particular, any of the following may be included, but not limited to, ascorbic acid, ascorbyl palmitate, calcium sulfate, citric acid, dibasic sodium phosphate, monobasic sodium phosphate, potassium carbonate, potassium citrate, sodium acetate, sodium ascorbate, sodium bicarbonate, sodium carbonate, sodium citrate, sodium lauryl sulfate, sodium metabisulfate, or combinations thereof.

Surfactants suitable for inclusion in formulations in the aqueous phase 1 and/or the drinks encapsulated within the marbles 2 of the present invention may include, but not limited to, aqueous sodium laurel sulfate, a tocopherol excipient, tocopherol polyethyleneglycol, beta-carotene, lycopene, or combinations thereof.

Preferably, CBD and/or THC oils may be encapsulated within the said marbles 2. The concentration and dosage of CBD and THC are within the permissible legal limits.

Preferably, the core of the marbles 2 may comprise fluorescent or bioluminescent components.

Preferably, the inner core of the marbles 2 may comprise chewable ingredients including the materials mentioned herein.

It will be clear to the skilled artisan that a variety of optional ingredients may be included in formulations of the invention. An exemplary embodiment of the invention comprises marble drink formulations comprising alkaline water, marbles comprising CBD oil, group of marbles comprising first flavouring (for example natural lemon lime flavouring), second group of marbles comprising second flavouring (for example marbles comprising natural strawberry flavouring), third group of marbles comprising maple syrup, fifth group of marbles comprising multi-vitamin complex, sixth group of marbles comprising first colouring agent (for example yellow), seventh group of marbles comprising second colouring agent (for example pink), and eighth group of marbles comprising natural sweetener stevia.

Several preferred embodiments of marble drink formulations include, but are not limited to, the following: alkaline flavoured ginger and ginseng infusion drink (pH 9.5), a group of marbles comprising CBD oil, a second group of marbles comprising lemon and lime natural flavouring, a third group of marbles comprising various colouring agents (for example orange, pink, blue, brown), and a fourth group of marbles comprising natural sweetener stevia.

This patent also provides embodiments of alkaline drinks (pH 8-11) whereby micro-encapsulated ingredients are used in the said alkaline drinks. This is particularly applicable to alkaline drinks produced by methods, apparatuses, and procedures related to patents with assigned publication numbers GB2550794 and WO2019/243759, and a patent with assigned application number GB1916731.1.

Ideally, dosages are monitored regularly using techniques well-known to the skilled artisan and adjusted as needed, preferably about every five weeks, to achieve the desired goal(s).

Herein, “individual” or “subject” refers to a human unless otherwise specified. Humans include children and adolescents.

Unless defined otherwise, all technical and scientific terms used herein have the same meaning as is commonly understood by one of skill in the art to which this invention belongs at the time of filing. All patents and publications referred to herein are incorporated by reference herein.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

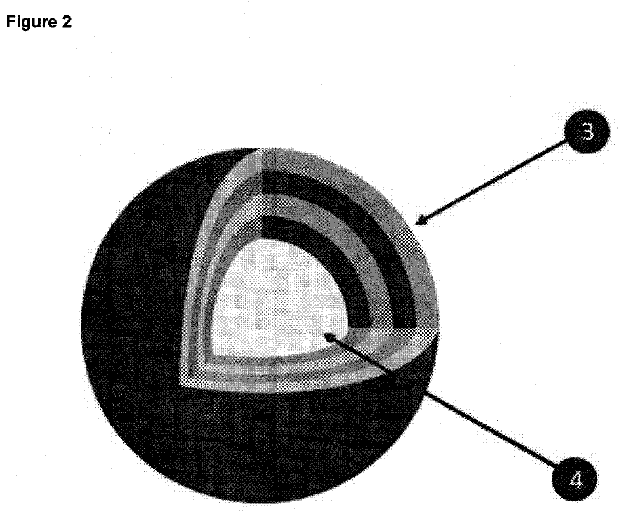

With reference to FIG. 2 of the accompanying drawings, the marbles in the embodiments in the present invention may be produced by various micro-encapsulation methods. Preferably, the double-nozzle micro-encapsulation process by Brace GmbH may be employed to create hard shell that encapsulated a hard or soft, could be liquid, core ingredients. The ingredients in the core of the marble are released at once pressure is applied by the consumer.

The marbles in the present invention comprise of an outer shell 3 and inner core ingredient(s) 4. The marbles may have a rectangular shape, triangular shape or preferably spherical shape as in the example give in FIG. 2. The marbles may not have a size of 2 mm or less. For instance, a spherical marble may not have a diameter of 2 mm or less.

The shell 3 in the marbles may be produced by various materials including, but not limited to, plant extract(s) or seaweed extract(s) or collagen(s) or sugar films, polymers such as gelatin, agar-agar, alginates or synthetic polymers such as resins or organics such as paraffin, fatty acids, waxes, or a mixture of any of the aforementioned materials, or any other liquids or materials that may be employed by the encapsulation methods.

The core of the marbles 4 may comprise various hard or soft ingredients as described herein.

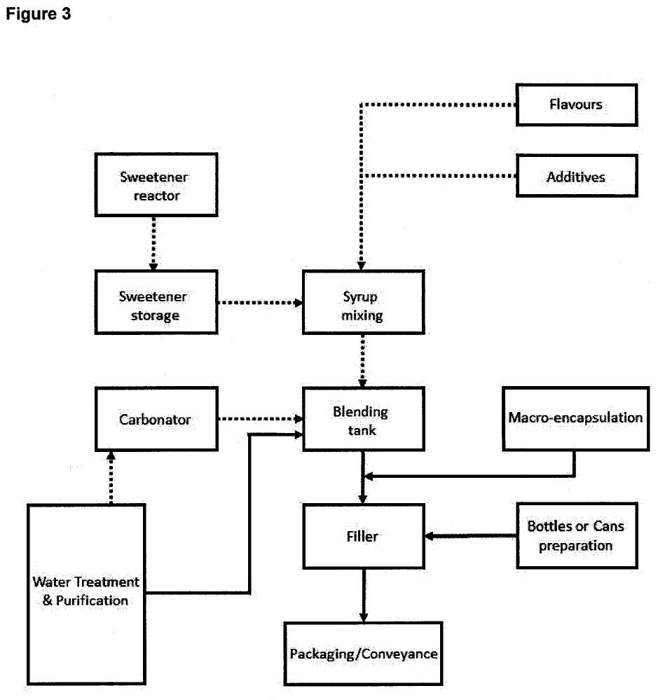

With reference to FIG. 3 of the accompanying drawings, the production of the embodiments in the present invention may undergo several stages including, but not limited to, water treatment or purification, water carbonation (optional), syrup production and mixing (optional), blending (optional), macro-encapsulation or marbles production, filling, macro-capsules or marbles filling, packaging or bottling.

The water treatment or purification methods used in this present invention may include any of the commonly used methods of water treatment and purification in the beverages industry including, but not limited to, reverse osmosis filtration, carbon filtration, micro- or nano-filtration, UV purification, ozone purification, desalination, de-ionisation filtration, and/or aeration. By using the aforementioned methods, water from various sources may be used including boreholes, spring water, river water, sea water or any other.

Water treatment in the present invention may also include the use of the methods, apparatuses, formulations, exemplary procedural or other details supplementary to those set forth herein for the production of alkaline water, are specifically incorporated herein by reference to patents with assigned publication numbers GB2550794 and WO2019/243759, and a patent with assigned application number GB1916731.1.

Water produced by the aforementioned methods water treatment and purification methods in the present invention may be used as the aqueous phase in the embodiments described herein and thus be used to fill in the blending tank directly for the purpose of filling in the bottles or packs or cans for the purpose of the production of the embodiments in the present invention.

Preferably, water produced by the aforementioned methods of water treatment and purification may be used for the production of the various drinks described herein and used as the aqueous phase in the embodiments in the present invention.

Preferably, water produced by the water treatment and purification methods in the present invention may be used in the macro-encapsulation processes for the production of the marbles in the embodiments.

Optionally, water carbonation, sweetener production reactor and storage, syrup production and mixing, flavours and/or additives mixing, and syrup blending methods may all or some be used in the production of the embodiments in this present invention. The dotted arrows in the accompanying FIG. 3 denote for the optional steps during the production of the embodiments in the present invention. Water carbonation may be employed if the aqueous phase in the embodiments comprise carbonated water or carbonated drink. Syrup production and mixing, flavours and/or additives mixing, and blending methods may all or some be employed when the aqueous phase or the core of the marbles comprise flavoured drink(s), juice(s), carbonated flavoured drink(s), CBD drink(s), non-alcoholic spirit drink(s), fermented drink(s), or any drink that may comprise flavouring agent(s), colouring agent(s), aromatic agent(s), or any other consumable ingredients.

Preferably, water produced by the water treatment and purification methods in the present invention may be used for water carbonation, sweetener production, syrup production, flavour preparation, and additives preparation.

Filling methods and apparatuses may be employed to fill in the bottles or packs or cans with the aqueous phase of the embodiments in this present invention. The present embodiments may be bottled or packaged in PET or PETE bottles, glass bottles, carton packs, Tetrapacks, metal bottles or cans, or any other bottling or packaging materials by using standard bottling or packaging methods in the beverages industry.

Macro-encapsulation or marble production may be employed for the production of the marbles in this present invention. The embodiments in this present invention comprise marbles of various sizes and shapes including, but not limited to spheres (preferably), rectangles, triangles or other geometrical shapes. The size of the marbles vary but may not be smaller than 2 mm in size. For instance, spherical marbles may not have a size with diameter of ≥2 mm.

Preferably, the embodiments of drinks in the present invention may comprise marbles of 1 size, 1 shape and 1 ingredient in the bottled/packaged/canned drink. Alternatively, the embodiments may comprise marbles of various sizes, various shapes and various ingredients inside the bottled/packaged/canned drink in this present invention.

The materials used in the production of the outer shell of the marble may comprise plant extract(s) or seaweed extract(s) or collagen(s) or polymers such as gelatin, agar-agar, alginates or synthetic polymers such as resins or organics such as paraffin, fatty acids, waxes, or a mixture of any of the aforementioned materials, or any other liquids or materials that may be employed by the encapsulation methods.

Preferably, water produced by the water treatment and purification methods in the present invention may be used in the macro-encapsulation processes for the production of the marbles in the embodiments.

Sorting of the marbles and filling of the bottles or packs or cans with the sorted marbles in the embodiments in this present invention may be employed to ensure filling the bottled/packaged/canned drink with the correct amount, size, shape, and type (e.g. colour type, core ingredient types) of marbles. This step is preferred to be employed prior to filling the bottles/packs/cans with the aqueous phase during production.

The embodiments in the present invention are bottled or packaged or canned drinks. Standard industry methods, apparatuses and technique may be employed to prepare, manufacture and sterilize the bottles or packs or cans used in the embodiments. For example, PET bottle production may require plastic blowing, cooling, rinsing and disinfection prior to filling with the contents of the embodiments in the present invention. Water produced by the water treatment and purification methods described herein may be used in the preparation and production of the bottles or packs or cans used in the production of the embodiments.

1. A bottled or packaged or canned drink comprising an aqueous phase and edible marbles or capsules immersed within the aqueous phase and encapsulating edible or drinkable or chewable ingredients.

2. The drink of claim 1 wherein the outer shell of the said marbles are made of edible materials including, but not limited to, gelatin or collagen or agar or alginate or plant extracts or seaweed extracts or biological polymers or synthetic polymers.

3. The drink of claim 1 wherein the aqueous phase comprises water or alkaline water or flavoured drink or a juice or a soft drink or a carbonated drink or an alcohol-free/non-alcoholic spirit or fermented drink or infusions or CBD drinks or any drink type thereof.

4. The drink of claim 1 wherein the said aqueous phase and/or the marbles may comprise natural and/or artificial flavours.

5. The drink of claim 1 wherein the said aqueous phase and/or marbles may comprise colouring agents.

6. The drink of claim 1 wherein the said aqueous phase and/or marbles may comprise CBD and/or THC oils.

7. The drink of claim 1 wherein the said aqueous phase and/or marbles may comprise artificial sweeteners or natural sweeteners.

8. The drink of claim 1 wherein the said aqueous phase and/or marbles may comprise syrups.

9. The drink of claim 1 wherein the said aqueous phase and/or marbles may comprise sugars and/or carbohydrates.

10. The drink of claim 1 wherein the said aqueous phase and/or marbles may comprise amino acids.

11. The drink of claim 1 wherein the said aqueous phase and/or marbles may comprise vitamins.

12. The drink of claim 1 wherein the said aqueous phase and/or marbles may comprise a triglyceride.

13. The drink of claim 1 wherein the said marbles may comprise a drink that is different than the drink in the said aqueous phase.

14. The drink of claim 1 wherein the said marbles may comprise any oil or oil-based component.

15. The drink of claim 1 wherein the said marbles may comprise fluorescent or bioluminescent components.

16. The drink of claim 1 wherein the marbles may comprise chewable ingredients.

17. The drink of claim 1 where the marbles may have a size no less than 2 mm.

18. The drink of claim 1 where the marbles may have various shapes and comprise various ingredients.

19. A drink whereby the aqueous phase is alkaline water (pH 8-11) and micro-encapsulated ingredients are used within.

20. The drink of claim 1 wherein any one or more of: the marbles may be produced in accordance with capsulation or encapsulation techniques; the drink is bottled or packaged or canned in accordance with bottling, packaging and canning techniques; or the said marbles may be added to any other liquid.

21. (canceled)

22. (canceled)
